(19) United States
(12) Patent Application Publication
(10) Pub. No.: US 2010/0171600 A1
(43) Pub. Date: Jul. 8, 2010

(54) REMOTE MESSAGING AND SECURITY SYSTEM

(76) Inventor: Ming-Yuan Wu, Taipei City (TW)

Correspondence Address: SINORICA, LLC, 2275 Research Blvd., Suite 500, ROCKVILLE, MD, 20850, US

(21) Appl. No.: 12/349,544

(22) Filed: Jan. 7, 2009

(51) Int. Cl. G07C 11/00

(52) U.S. Cl. 340/286.06

(57) ABSTRACT

A message and security system comprising a visitor message device and a host message device is disclosed. The host message device allows a host to select a message or status which is indicated or displayed on the visitor message device. The messages can be personalized so that a visitor after inputting identification information is given an appropriate message. A lock controller connected to the host message device locks and unlocks entrances. A host remote device remotely controls and communications with the host message device and the visitor message device.

### BACKGROUND OF THE INVENTION

1. Field of the Invention

The present invention relates to a messaging and security system. More specifically, the present invention discloses a system that allows a host to remotely set a message to be displayed for a visitor and remotely control access and authorization.

2. Description of the Prior Art

Messaging or contact systems are used to respond to callers or visitors. These systems allow a caller to leave a message or allow a visitor to notify a party that they have arrived.

Refer to FIG. 1A which is a drawing illustrating a telephone messaging system of the prior art.

The prior art telephone messaging system 100 includes a visitor telephone 110 and an operator telephone 120. The operator telephone 120 also includes a recorder with memory. When a visitor wants to contact a person or company having the operator telephone 120, the visitor uses the visitor telephone 110 to make a call to the operator telephone 120. The visitor telephone 110 and the operator telephone 120 are connected by a wired telephone line 115. A prerecorded message is stored in the memory of the operator telephone 120 and played for the visitor to hear. The visitor also has the option of leaving a message which is then stored in the memory of the operator telephone 120. However, in the conventional telephone messaging system only one prerecorded message can be stored and all visitors calling the operator telephone 120 hear the same message. As a result, this type of system does not allow for personalization and visitors feel neglected.

Refer to FIG. 1B which is a door entry communication system of the prior art. The prior art door entry communication system 130 includes a visitor communication device 140A and an operator communication device 140B. The visitor communication device 140A includes a speaker and microphone 150A and a keypad 160A. The operator communication device 140B also includes a speaker and microphone 150B and a keypad 160B. The visitor communication device 140A and the operator communication device 140B are connected by a wired line 145.

When a visitor arrives at a location where the door entry communication system 130 is installed, the visitor presses a key or number of keys on the keypad 160A of the visitor communication device 140A. A person on the inside of the location is notified by a buzz or ring emitted from the speaker 150B of the operator communication device 140B. The person answers the visitor's contact request by pressing a key on the keypad 160B of the operator communication device 140B. The visitor and the person on the inside of the location communicate using their respective devices 140A 140B. If the visitor is allowed entrance the operator communication device 140B sends a signal to the lock on the entrance door thereby unlocking the door and the visitor is able to enter.

However, this conventional system requires a person to physically be present in order to permit a visitor to enter the location. This is not convenient and often not practical. In addition, if no one is available to meet the visitor, the visitor is met with silence and a neglected feeling.

Therefore, there is need for an improved remote messaging and security system that provides a personalized message and entrance permissions according to each visitor or caller.

### SUMMARY OF THE INVENTION

To achieve these and other advantages and in order to overcome the disadvantages of the conventional method in accordance with the purpose of the invention as embodied and broadly described herein, the present invention provides a remote messaging and security system that provides a personalized message and entrance permissions according to each visitor or caller.

The personalized messaging and security system of the present invention comprises a visitor messaging and communication device and a host messaging and communication device.

The visitor message device is used for providing a message to a visitor or caller. The host message device connects or is connected to the visitor message device and is used for selecting the message or status and for sending the message to the visitor message device.

The basic visitor message device comprises a plurality of light emitting diodes. Each of the light emitting diodes indicates a different status and is labeled accordingly. For example, “busy”, “away”, “in a meeting”, etc.

The basic host message device comprises a plurality of switches, buttons, or a dial with multiple switch positions that are selectable to activate individual light emitting diodes of the visitor message device. When the host selects a status or message using the host message device the corresponding light emitting diode lights up. A visitor arriving at the facility quickly understands the host's status and acts accordingly.

Alternately, the visitor message device comprises a display for displaying messages. When the visitor arrives at the facility they are greeted with a text or video message. This allows for providing more complex or detailed messages.

The messaging and security system further comprises a lock controller coupled to the host message device for locking and unlocking an entrance. In this way the host using the host message device can grant or deny access to visitors by locking or unlocking the entrance.

An advanced messaging and security system of the present invention comprises an advanced visitor message device and an advanced host message device.

The visitor message device comprises a camera for capturing a visitor's image, a display for displaying a host's image or message, a microphone for capturing a visitor's voice, a speaker for emitting a host's voice or message, and an information input device for inputting a visitor's identification information.

The host message device is connected to or connectable to the visitor message device and comprises a memory for storing messages, a menu system for designating messages according to visitors, and a selecting means for selecting and sending messages to the visitor message device. The host message device is, for example, a computer, a telephone, a personal digital assistant, etc.

The messaging system further comprises a host remote device connectable to the host message device for communicating with the host message device and the visitor message device. The host remote device comprises, for example, a telephone, a personal digital assistant, or a portable computer. The host remote device communicates with the host message device to operate the lock controller to lock and unlock an entrance. The entrance is, for example, an entry door, a gate, a mailbox door, a garage door, a doggy door, a dog kennel door, an electric door, an interior door, or a combination of these.

The information input device of the visitor message device comprises a keypad, a biometric reader, image scanner, fingerprint scanner, iris scanner, facial recognition scanner, DNA scanner, or other type of device that is able to obtain information in order to determine or verify a visitor's identity. When a visitor arrives and provides their identification information the data is verified by the host message device. According to the visitor's identity various operations occur, for example, communication is established, communication is denied, communication is transferred to the host remote device, a message is played, a personalized message is played, the visitor is allowed to leave a message, etc.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1A is a drawing illustrating a telephone messaging system of the prior art;

FIG. 1B is a door entry communication system of the prior art;

FIGS. 2A-2E are drawings illustrating personalized messaging and communication systems according to embodiments of the present invention;

FIGS. 3A-3D are flowcharts illustrating methods of providing a message to a visitor or caller;

FIG. 3E is a flowchart illustrating a method of providing a message or granting access to a visitor or caller; and

FIGS. 4A-4B are drawings illustrating remote messaging systems according to embodiments of the present invention.

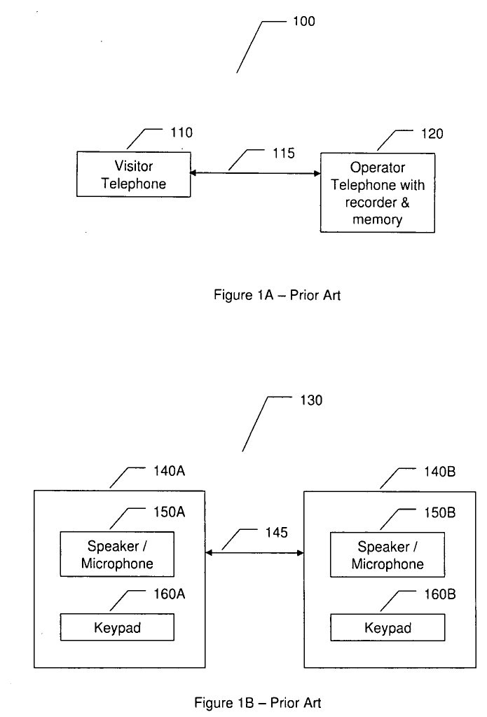

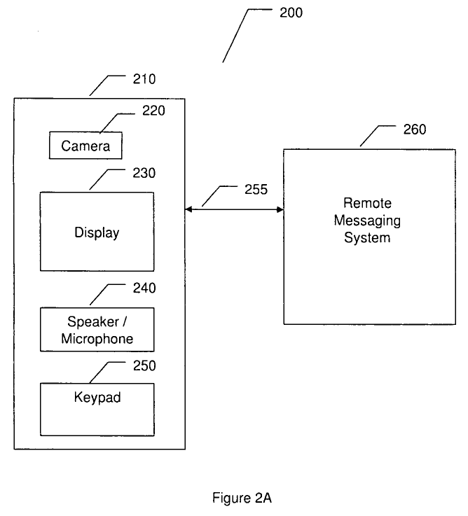

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

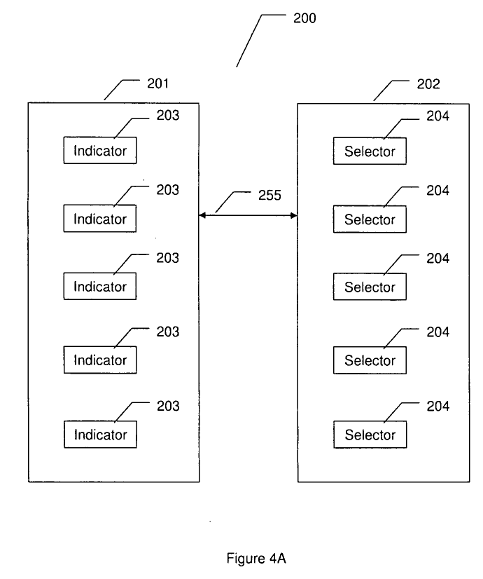

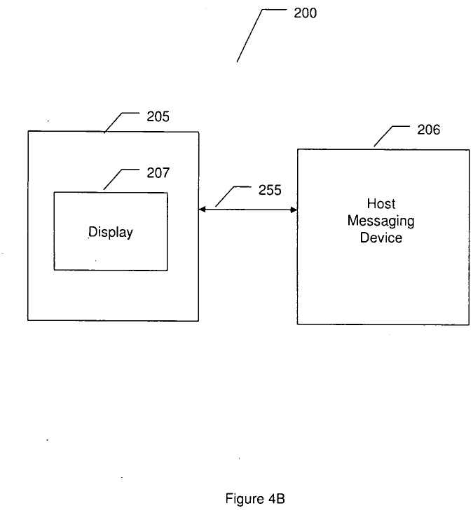

Refer to FIG. 4A, which is a drawing illustrating a remote messaging system according to an embodiment of the present invention.

In the embodiment illustrated in FIG. 4A the remote messaging system 200 comprises a visitor message device 201 and a host messaging device 202. The visitor message device 201 comprises a plurality of indicators 203, for example, a plurality of light emitting diodes that act as status indicators. Each indicator 203 signifies a host status, for example, busy, away, closed, return tomorrow, etc. The host messaging device 202 comprises a plurality of selectors or switches 204. The host uses the host messaging device 202 to select a desired status by using the appropriate switch 204 related to the desired status. The host messaging device 202 is coupled to the visitor message device 201 and the host messaging device 202 controls the visitor message device 201 to turn on the selected status indicator 203.

When a visitor arrives at the facility where the remote messaging system 200 is installed they will see the status of the host. For example, if the host is away on business the status indicator associated with “away” is active and the visitor will understand. Or for example, the host is in a meeting the “in meeting” or “busy” indicator is active and the visitor won't disturb the host.

Refer to FIG. 4B, which is a drawing illustrating a remote messaging system according to an embodiment of the present invention.

As shown in FIG. 4B the remote messaging system 200 comprises a visitor message device 205 and a host messaging device 206. The visitor message device 205 comprises a display 207, for example, an LED or LCD display. The host messaging device 206 comprises, for example, a computer. The host selects a desired status from, for example, a menu. The host messaging device 206 controls the visitor message device 205 to display the selected status message on the display 207.

In an embodiment of the present invention the selected status message is continuously displayed. In another embodiment the selected status message is displayed when a visitor arrives at the facility and presses a button, for example, a door bell button. In another embodiment the selected status message is displayed when a sensor detects a physical presence.

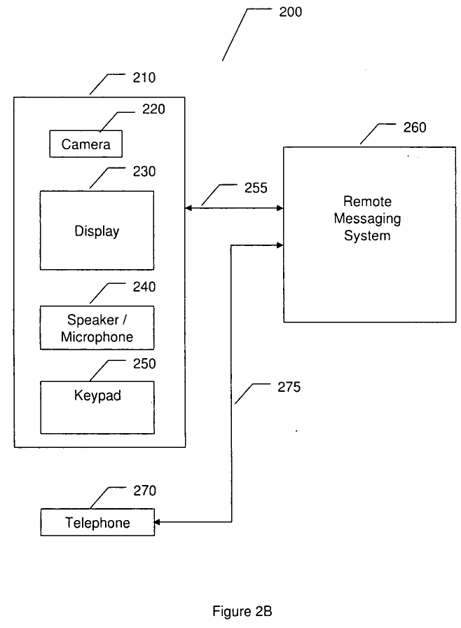

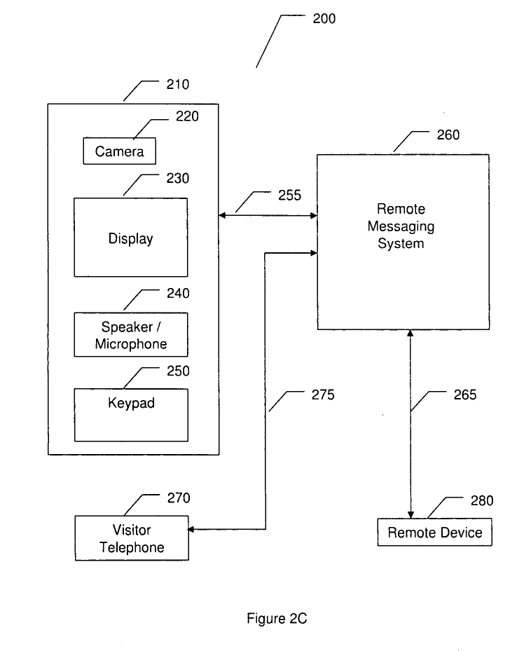

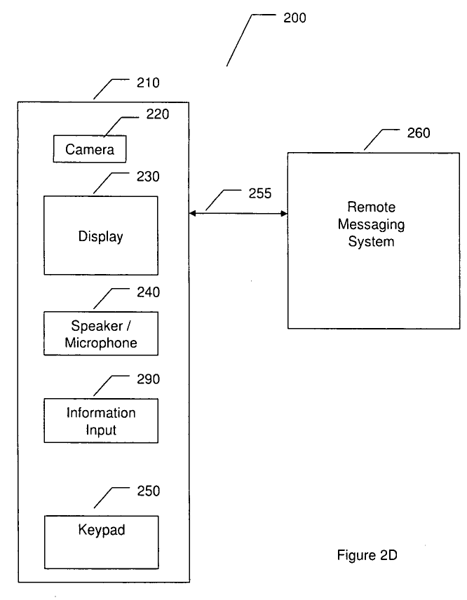

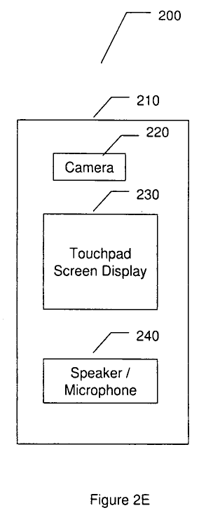

Refer to FIG. 2A which is a drawing illustrating a personalized messaging and communication system according to an embodiment of the present invention.

As shown in FIG. 2A the personalized messaging and communication system 200 comprises a visitor communication device 210 and a host messaging system 260. The visitor communication device 210 comprises a camera 220, a display 230, a speaker and microphone 240, and a keypad 250. The visitor communication device 210 and the host messaging system 260 are linked via a connection link 255, for example, a wired line or a wireless connection such as a wi-fi, wi-max, Bluetooth, or 3G connection.

The host messaging system 260 comprises a memory device for storing messages. When a visitor or caller contacts the host messaging system 260 using the visitor communication device 210 the host messaging system 260 determines the identity of the visitor and selects and plays an appropriate message for the visitor. The appropriate message comprises, for example an audio message, a video message, or an audio video message. When the message comprises audio, the audio is broadcast from the speaker 240 and when the message comprises video, the video is displayed on the display 230.

In an embodiment of the present invention when the visitor is identified and has been selected to be granted the authority the entrance door is unlocked and the visitor is allowed to enter the premises.

The visitor is identified by the host messaging system 260 by, for example, a code entered by the visitor on the keypad 250.

In an embodiment of the present invention the visitor communication device 210 is a dedicated device installed at an entrance of a facility or building. In another embodiment the visitor communication device is an electronic communication device, for example, a computer, a PDA, a telephone, or a mobile telephone.

Refer to FIG. 2B which is a drawing illustrating a personalized messaging and communication system according to an embodiment of the present invention.

The embodiment illustrated in FIG. 2B is similar to the embodiment illustrated in FIG. 2A with the addition of a visitor telephone 270. In the embodiment illustrated in FIG. 2B when a visitor wants to contact the host messaging system 260 the visitor has the option of utilizing the visitor communication device 210 or the visitor telephone 270.

In this embodiment when the visitor uses the visitor telephone 270 to contact the host messaging system 260 the visitor is identified by, for example, caller ID or a code entered on the keypad of the visitor telephone 270.

In an embodiment of the present invention the visitor communication device connection link 255 and the visitor telephone connection link 275 are the same link. In another embodiment the connection links 255 275 are separate connection links.

In an embodiment of the present invention the visitor telephone 270 is the property of the host. In an embodiment of the present invention the visitor telephone 270 is the property of the visitor. For example, the visitor telephone is the visitor's personal mobile telephone.

Refer to FIG. 2C which is a drawing illustrating a personalized messaging and communication system according to an embodiment of the present invention.

The embodiment illustrated in FIG. 2C is similar to the embodiment illustrated in FIG. 2B with the addition of a host remote device 280. In this embodiment the host messaging and security system 260 is programmable so that when a visitor contacts the host messaging and security system 260 a personalized message appropriate to the visitor is played or the communication contact is transferred to a host remote device 280. The host remote device 280 is, for example, a mobile telephone, a computer, or a PDA and connects to the host messaging and security system via a wired or wireless connection 265. For example, visitor A can be selected to receive message A when they contact the host messaging and security system and visitor B can be selected to be transferred to the host remote device. In this way certain visitors can be transferred to a host remote device without knowing or revealing the telephone number or IP address of the host remote device.

Further, the host remote device is capable of remotely controlling the host messaging and security system. For example, visitor C arrives at the facility and uses the visitor telephone or the visitor communication device to contact the host messaging and security system and visitor C has been preselected to have their communication transferred to the host remote device, the host can use the host remote device to unlock the entrance door and allow visitor C to enter the facility without the host being present.

For and example the following scenario is given. Fred Smith owns a business with a warehouse in China but is frequently away on business. Rather than giving out a code or identification card to open the door to the warehouse to suppliers, employees, or delivery personnel, he uses the remote messaging and security system of the present invention. When Michael, a deliveryman for a paper supplier, arrives at the warehouse he uses the visitor telephone or the visitor communication device and the host messaging and security system is contacted. The connection or telephone call is transferred to Fred's remote device. After communicating with Michael, Fred sends an open door command from his remote device to the host messaging and security system which in turn sends a signal to the lock on the entrance door commanding the lock to unlock thus allowing Michael to enter the warehouse. After completing his delivery Michael exits the warehouse. The host messaging and security system recognizes Michael has left and sends a notice to Fred's remote device. In this way, Michael does not need to know a code or have an identification badge to enter the warehouse but Fred is able to grant entrance safely from a remote location. Further, Fred is able to lock the entrance door remotely. For example, if Fred forgot to lock the door or if Michael has not left the warehouse in a timely manner, Fred can lock the door until security arrives. Additionally, using a camera or cameras Fred is able to contact the host messaging and security system to view his facility. The cameras, camera positions, camera selection, and video from the cameras are also controlled by the host messaging and security system and the host remote device.

Refer to FIG. 2D which is a drawing illustrating a personalized messaging and security system according to an embodiment of the present invention.

In the embodiment illustrated in FIG. 2D the visitor communication device 210 further comprises a visitor information input device 290. The visitor information input device 290 is, for example, a biometric reader, image scanner, fingerprint scanner, iris scanner, facial recognition scanner, DNA scanner, or other type of device that is able to obtain information to determine or verify a visitor's identity. The addition of the visitor information input device 290 increases the security level of the remote messaging and security system 200.

Refer to FIG. 2E, which is a drawing illustrating a visitor communication device according to an embodiment of the present invention.

The visitor communication device 210 comprises a camera 220, a speaker/microphone 240, and a touch screen display 230. The touch screen display 230 adds convenience as the visitor can communicate or leave messages by touching various icons on the display 230.

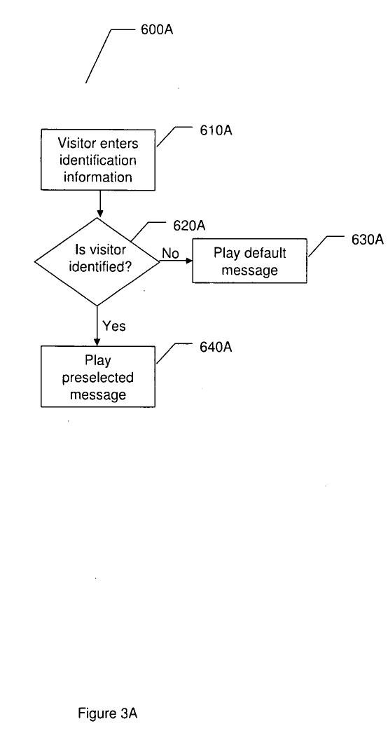

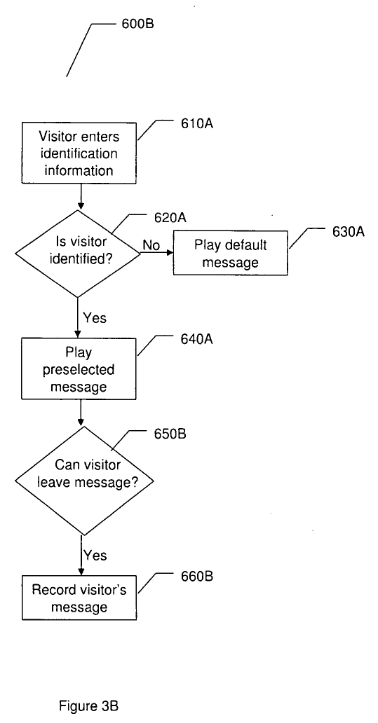

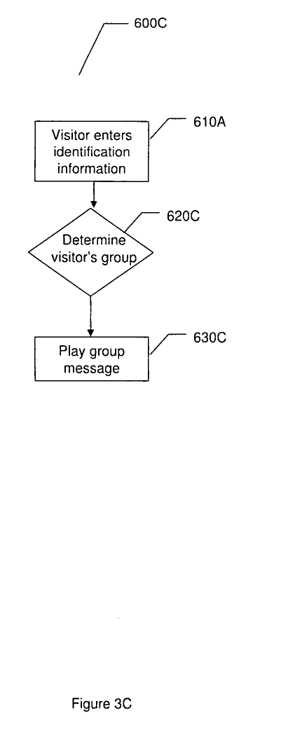

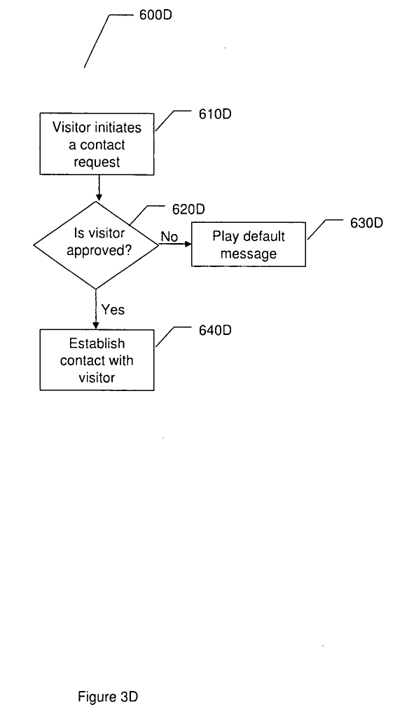

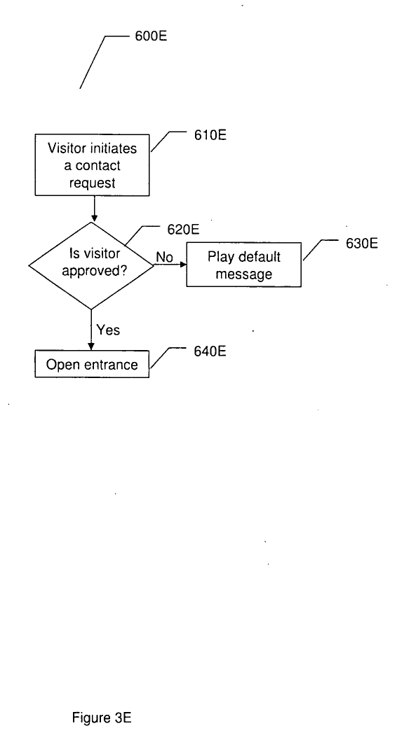

Refer to FIG. 3A, which is a flowchart illustrating a method of providing a message to a visitor or caller.

The method 600A begins by the visitor entering identification information using the visitor communication device or telephone in Step 610A. The identification information is, for example, a code, the visitor's name, the visitor's company, a password, caller ID, the visitor's phone number, or biometric data such as a fingerprint, fingerprints, DNA, or voice.

In embodiments of the present invention the visitor a single piece of identification information. In other embodiments of the present invention the visitor provides a plurality of identification information.

Next, in Step 620A the host messaging system determines whether or not the identification information is valid and identifies the visitor. If the host messaging cannot identify the visitor or the visitor has not been chosen to receive a preselected message a default message is played or displayed in Step 630A. If the visitor is identified and has been chosen to receive a preselected message the appropriate message is played or displayed in Step 640A.

Refer to FIG. 3B, which is a flowchart illustrating a method of providing a message to a visitor or caller.

The method 600B illustrated in FIG. 3B is similar to the embodiment in FIG. 3A with the addition of two steps. After the message has been played or displayed in Step 640A the host messaging system determines whether or not the visitor has been approved to leave a message for the host in Step 650B. If the visitor is allowed to leave a message the host messaging system records the visitor's message in Step 660B. The host is able to replay the visitor's message remotely or locally from the host messaging system. If the visitor hasn't been approved to leave a message the visitor isn't given the opportunity or option to leave a message.

In an embodiment of the present invention the host messaging system provides a menu interface for the host to use to select messages for various visitors. For example, menu options are provided for standard messages such as “out of the office”, “closed”, “out for lunch”, “on holiday”, etc. Some options have sub-options. For example, “visiting clients” has sub-options such as “back in 1 hour”, and “back soon, please wait”. Some sub-options also have sub-options. For example, “on holiday” has sub-options of “back on Monday” and “back on” with the “back on” sub-option having a sub-option of selecting a specific time or date of when the host will return. Other options are, for example, “out of office please call 0945-125-354”.

Additionally, options are provided in the interface for enabling specific visitors to leave messages, enabling automatic call forwarding to transfer the visitor to the host, automatic door unlock, etc. Also, various options are provided to allow the host to record a new or personalized message for individuals or group of visitors.

The host is able to remotely or locally manage, record, and set messages and access rights.

Refer to FIG. 3C, which is a flowchart illustrating a method of providing a message to a visitor or caller.

The method 600C begins in Step 610A with the visitor providing identification information. After the host messaging system identifies the visitor the visitor's group is determined in Step 620C. In Step 630C a preselected group message is played or displayed for the visitor.

The group message is an appropriate message based on a group or category that the visitor has been assigned to by the host. For example, visitors are assigned into groups such as “clients”, “friends”, “suppliers”, or “family”. When a visitor contacts the host messaging system the visitor's identity is verified and the visitor's group is determined. The message, authority, access, or action that is provided is appropriate for the visitor's group. For example, visitors assigned to the client group receive the same professional message and visitors assigned to the friend group receive a more informal message. A visitor that hasn't been assigned to a group receives a default message.

Refer to FIG. 3D, which is a flowchart illustrating a method of providing a message to a visitor or caller.

The method 600D begins in Step 610D when a visitor or caller initiates a contact request. If the visitor is authorized to make contact the communication is established with the host message device or transferred to the host remote device in Step 640D. If the visitor has not been approved a default message is played in Step 630D. The method illustrated in FIG. 3D provides an effective means of screening visitors ensuring the host won't be disturbed by unknown or unwanted visitors or callers.

Refer to FIG. 3E which is a flowchart illustrating a method of providing a message or granting access to a visitor or caller.

The method 600E in FIG. 3E is similar to the embodiment illustrated in FIG. 3B. However, in FIG. 3E if the visitor is approved in Step 620E, the entry door is unlocked allowing the visitor to enter the facility in Step 640E.

In an embodiment of the present invention the messaging and security system further comprises a utilities controller connectable to the host message device for turning on and turning off utilities. For example, utilities such as electricity, water, gas, or a combination of these are controlled by the host message device or the host remote device. This allows utilities to be turned off remotely. For example, if the host is away on vacation and forgot to turn off his coffee pot, the host uses the host remote device to turn it off, turn the outlet off, or turn off all electricity. Obviously, the host message device would retain power at all times.

In an embodiment of the present invention a plurality of lock controllers are utilized. This allows the host message and security device to control access to various parts of the facility. For example, a messenger can be given access to only the lobby in order to deliver items. The receptionist can be given access to the lobby, reception area, and the restroom, etc. Since the lock controllers are remotely controllable, the host can grant access temporarily without granting access permanently. For example, the host can unlock a doggy door temporarily so his pet can go outside. When the pet returns and enters, the host can lock the door.

In an embodiment of the present invention a master or super lock function is provided. This function locks or unlocks all locks controlled by the lock controller. Similarly, the utilities control turns off or on all utilities. This function is convenient for landlords or vacationers. If a tenant fails to pay the rent the landlord can turn off all utilities and lock all locks easily and the landlord doesn't need to replace the locks and keys.

In an embodiment of the present invention an alert message is sent to the host remote device if an alarm or sensor trips. For example, if a fire alarm sounds a message indicating a potential fire is sent to the host remote device by the host message device and the host can take appropriate action. Additionally, the host can remotely trigger or reset alarms or sensors.

In an embodiment of the present invention the host message device and the lock controller provide a key-less entry system. By inputting identification information such as a fingerprint or fingerprints an authorized person can enter the area or areas.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A messaging system comprising:
a visitor message device for providing a message to a visitor or caller; and
a host message device connectable to the visitor message device for selecting the message and sending the message to the visitor message device.

2. The messaging system of claim 1, the visitor message device comprising a plurality of light emitting diodes, each of the plurality of light emitting diodes indicating a different status.

3. The messaging system of claim 1, the host message device comprising a plurality of switches or switch positions selectable to activate individual light emitting diodes of the visitor message device.

4. The messaging system of claim 1, the visitor message device comprising a display for displaying messages.

5. The messaging system of claim 1, further comprising a lock controller coupled to the host message device for locking and unlocking an entrance.

6. A messaging system comprising:
a visitor message device for providing a message to a visitor or caller, the visitor message device comprising a plurality of light emitting diodes, each of the plurality of light emitting diodes indicating a different status; and
a host message device connectable to the visitor message device for selecting the message and sending the message to the visitor message device, the host message device comprising a plurality of switches selectable to active individual light emitting diodes of the visitor message device.

7. The messaging system of claim 6, further comprising a lock controller coupled to the host message device for locking and unlocking an entrance.

8. A messaging system comprising:
a visitor message device, the visitor message device comprising:
a camera for capturing a visitor's image;
a display for displaying a host's image or message;
a microphone for capturing a visitor's voice;
a speaker for emitting a host's voice or message; and
an information input device for inputting a visitor's identification information; and
a host message device connectable to the visitor message device, the host message device comprising:
a memory for storing messages;
a menu system for designating messages according to visitors; and
a selecting means for selecting and sending messages to the visitor message device.

9. The messaging system of claim 8, further comprising a lock controller coupled to the host message device for locking and unlocking an entrance.

10. The messaging system of claim 8, further comprising a host remote device connectable to the host message device for communicating with the host message device and the visitor message device.

11. The messaging system of claim 10, the host remote device comprising a telephone, a personal digital assistant, or a portable computer.

12. The messaging system of claim 8, wherein messages vary according to the visitor's identification information.

13. The messaging system of claim 10, wherein the host remote device communicates with the host message device to operate a lock controller to lock and unlock an entrance.

14. The messaging system of claim 8, the information input device comprising a keypad, a biometric reader, image scanner, fingerprint scanner, iris scanner, facial recognition scanner, DNA scanner, or other type of device that is able to obtain information in order to determine or verify a visitor's identity.

15. The messaging system of claim 8, the host message device further comprising a recording means for recording a visitor's message.

16. The messaging system of claim 8, the host message device further comprising call transfer means for transferring visitor communication and host communication between the visitor message device and a host remote device.

17. The message system of claim 9, wherein the lock controller locks and unlocks an entry door, a gate, a mailbox door, a garage door, a doggy door, a dog kennel door, an electric door, an interior door, or a combination of these.

18. The messaging system of claim 8, further comprising a utilities controller connectable to the host message device for turning on and turning off utilities.

19. The messaging system of claim 18, wherein utilities comprise electricity, water, gas, or a combination of these.
